(19) United States
(12) Patent Application Publication
(10) Pub. No.: US 2003/0235375 A1
(43) Pub. Date: Dec. 25, 2003

(54) Transceivers with improved cross talk

(76) Inventors: Kishore K. Kamath, Allentown, PA (US); Ihab E. Khalouf, Allentown, PA (US); Sunil Priyadarshi, Macungie, PA (US)

Correspondence Address: Lester H. Birnbaum, 6308 Sauterne Drive, Macungie, PA, 18062, US

(21) Appl. No.: 10/183,138

(22) Filed: Jun. 25, 2002

(51) Int. Cl. G02B 6/42

(52) U.S. Cl. 385/92

(57) ABSTRACT

A transceiver and method of fabrication where the housing comprises a carrier upon which the source and photodetector are mounted and a cover. The housing includes an integral wall extending between the source and photodetector so as to electrically isolate the two devices. The cover may physically contact the wall to provide grounding for the cover.

### FIELD OF THE INVENTION

The present invention relates generally to optoelectronics and, more particularly, to a transceiver with reduced cross talk and improved noise immunity.

### BACKGROUND OF THE INVENTION

Optical systems are critical to modern telecommunications primarily due to their immense information handling capacity. Such systems usually include, at the transmission end, one or more light sources for generating the light, an optical modulator for impressing information on the light, an optical fiber for transmitting light and, at the receiving end, a photodetector for converting the optical signal to an electrical signal. Other components, such as optical amplifiers and optical isolators, are also included.

In bi-directional systems, the two ends of the systems usually utilize a combination of transmitter and receiver in the same package (Transceiver). In order to improve packing densities, it is desirable to make the package as small as possible. One technique for forming such a small package, is to mount the transmitter and receiver boards vertically in close proximity. (See, U.S. Pat. No. 6,024,500 issued to Wolf.) One potential problem with such an arrangement is that the transmitter could radiate electromagnetic energy in the form of noise to the receiver, possibly causing receiver sensitivity to degrade.

It has been previously proposed to provide a separate shield mounted over the receiver board to alleviate this problem. However, such an approach has limited application since one has to connect the shield to circuit ground, which will conduct the noise to circuit ground resulting in a degradation of the quality of circuit ground. A more preferred option would be to connect the shield to chassis ground, which is difficult to implement in the discrete shield design. In addition, a separate shield also increases the cost of the package by the addition of piece parts and additional assembly time.

It is therefore desirable to improve the performance of transceivers without significantly increasing their cost of manufacture.

### SUMMARY OF THE INVENTION

The present invention in one aspect, is a transceiver which includes a housing, and an optical source and optical photodetector mounted therein. The housing comprises a carrier upon which the source and photodetector are mounted and a cover mounted over the carrier. The housing includes an integral wall extending between the source and photodetector so as to electrically isolate the two devices. The cover may physically contact the wall to provide grounding for the cover.

In accordance with another aspect, the invention is a method of fabricating a transceiver including the steps of providing a housing comprising a carrier and cover and having an integral wall, and mounting the source and photodetector in the carrier on opposite sides of the wall to electrically isolate the two devices. The cover may be physically contacting the wall to provide grounding for the cover.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. It is emphasized that, according to common practice in the semiconductor industry, the various features of the drawing are not to scale. On the contrary, the dimensions of the various features are arbitrarily expanded or reduced for clarity. Included in the drawing are the following figures:

FIG. 1 is a perspective view of a carrier in accordance with an embodiment of the invention;

FIG. 2 is an exploded, perspective view of an assembled transceiver in accordance with the same embodiment; and

FIG. 3 is a different perspective view of the transceiver of FIG. 2.

### DETAILED DESCRIPTION OF THE INVENTION

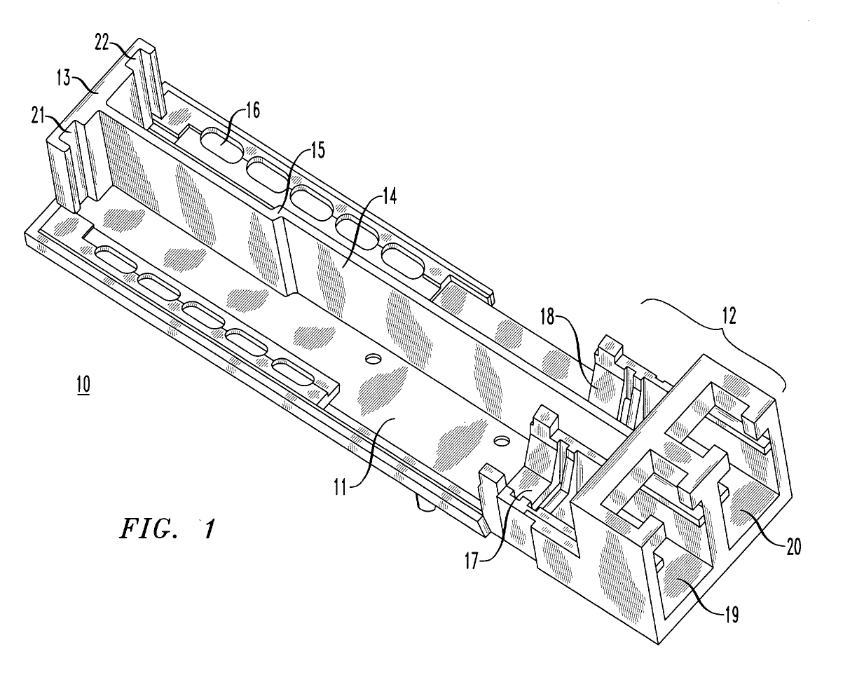

Referring now to the drawing, wherein like reference numerals refer to like elements throughout, FIG. 1 is a perspective view of a carrier, 10, which may be used in a transceiver in accordance with an embodiment of the invention. The carrier is typically made of a metal such as zinc. The carrier includes a base portion, 11, on which the transmitter and receiver boards will be mounted, a front section, 12, for receiving optical connectors mounted to the boards and for receiving optical fibers, and a rear section, 13. In particular, the portion, 12, includes slots 17 and 18, which accommodate standard LC connectors, and receptacles, 19 and 20, which receive standard LC plugs on the ends of optical fibers. The carrier design can be modified to accommodate other optical connectors. The rear section, 13, preferably includes slots, 21 and 22, which receive the back edges of the transmitter and receiver boards.

A wall, 14, is preferably integral with the carrier and extends from the base portion, 11, to approximately the height of the carrier. Preferably, the wall, 14, is integral with both the base, 11, and the rear portion, 13. In this embodiment, the wall, 14, includes a kink, 15, in order to accommodate the larger width of the receiver board, but may not be needed in other transceiver designs. In this embodiment, the wall was approximately 0.328 inches high (8.33 mm) and 0.020 inches thick (500 microns). In general, thicknesses in the range 0.005 inches to 0.040 inches (127 to 1,016 microns) should be useful. Preferably, the thickness of the wall for this design is in the range 0.017 to 0.023 inches (432 to 584 microns). The height of the wall in this design is preferably 0.323 to 0.333 inches (8.20 to 8.46 mm). In general, heights in the range 0.100 to 1.0 inches (2.54 to 25.4 mm) should be useful.

The base portion, 11, further includes apertures, e.g., 16, through which connecting pins from the boards will extend for electrical connection to other components.

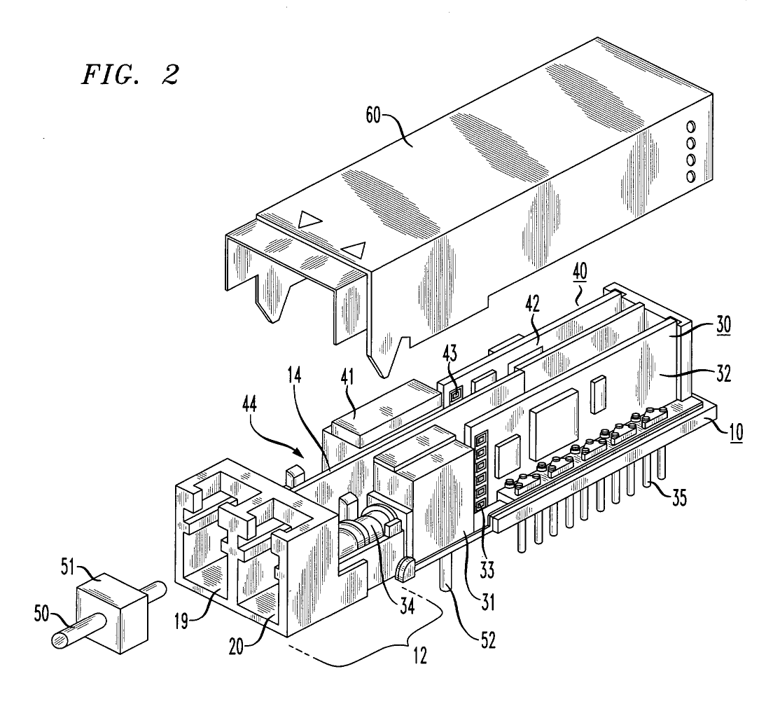

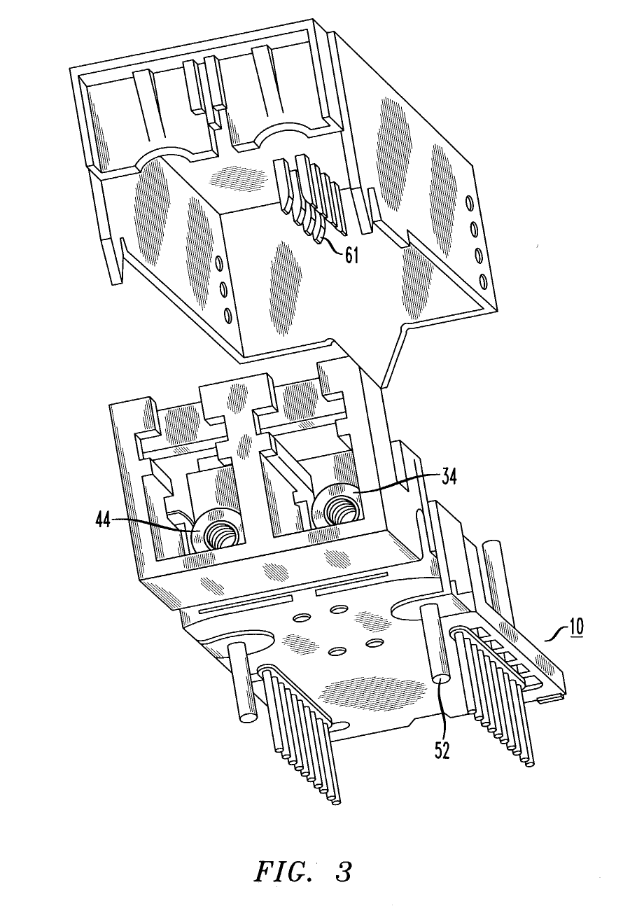

FIGS. 2 and 3 illustrate, in top and bottom exploded perspective views, an essentially complete transceiver utilizing the carrier of FIG. 1. The transmitter board, 40, and receiver board, 30, have been placed vertically onto the base, 11, on opposite sides of the wall, 14. Typically, each board is complete prior to insertion in the carrier. Thus, the receiver board, 30, typically includes a photodetector, 31, which is electrically coupled through leads, 33, to a circuit board, 32, including electronics for operating the photodetector. The front end of the photodetector, 31, is optically coupled to an LC connector, 34. Similarly, the transmitter board, 40, typically includes a laser, 41, which is electrically connected through leads, 43, to a circuit board, 42, including electronics for operating the laser. The front end of the laser is optically connected to an LC connector, which is not visible in the view of FIG. 2, but can be seen as 44 in FIG. 3.

Each board, 30 and 40, is inserted in the carrier, 10, so that the rear edges are guided by slots, 22 and 21, respectively, in the rear portion, 13. The boards' electrical connection pins, e.g., 35, extend through a corresponding aperture, e.g., 16, in the base, and the LC connectors, 34 and 44, rest in corresponding slots 18 and 17, in the front section, 12. The front section, 12, is designed so that optical connection of the boards to corresponding optical fibers, e.g., 50, is effected by plugging an LC connector plug, 51, on the fiber into a corresponding receptacle 19 or 20. Posts, e.g., 52, on the bottom of the carrier can be used to mount the transceiver to a mother board (not shown) in order to electrically connect the boards, 30 and 40, to components on the mother board.

It will be noted that the wall, 14, will shield the receiver board 30, from electromagnetic radiation from the transmitter board, 40, which radiation could otherwise affect the receiver sensitivity. In this example, the transceiver exhibited less than 0.5 dB in cross talk at 2.48832 Gbps. The transceiver also met industry standards for Electro Magnetic Compatibility (EMC) performance, ie, EN 55022 class B for radiation, EN 61000-4-3 performance criteria A for immunity, and EN 61000-4-2 for Electrostatic discharge (ESD). Further, since the wall, 14, is an integral member of the carrier, 10, no additional piece parts are required which can increase assembly costs.

With further reference to FIGS. 2 and 3, the housing of the transceiver, in addition to the carrier, 10, preferably also includes a cover, 60, which is mounted over the carrier, 10, typically by an interference fit. The cover, 60, is typically made of the same metal as the carrier, 10, and functions primarily to protect the components in the housing from external electromagnetic radiation, ESD, and outside contaminants. As illustrated in FIG. 3, the cover desirably includes conductive fingers, 61, which are integral with the cover and extend downward from the top portion of the cover toward the carrier, 10. When the cover, 60, is mounted to the carrier, 10, the fingers mechanically and electrically connect to the wall, 14. Thus, the wall, 14, which is electrically grounded to the carrier, 10, provides an additional benefit by improving the grounding of the cover, 60, thereby improving the EMC performance of the housing.

It should be understood that the invention is most advantageous for use in transceivers having vertically mounted transmitter and receiver boards which face each other so that electromagnetic radiation from the transmitter board would, without a shield, adversely affect the receiver board. However, the invention could be used in other types of designs such as plugable transceivers and transponders. In the context of this application, the term “transceiver” is intended to include any optoelectronic device which includes an optical source and photodetector in close proximity (less than 6.25 mm) in the same package where it is desirable to shield one device from the other.

While the example described includes a wall, 14, which is integral with the base of the carrier, 10, the wall could also be integral with the cover, 60, as long as the wall is positioned between the transmitter and receiver boards, 40 and 30, in the assembled device. Further, the wall may be integral with only the rear portion, 13, of the carrier, 10, in some designs, but is not generally preferred, since better grounding is achieved when the wall contacts the base.

Although the invention has been described with reference to exemplary embodiments, it is not limited to those embodiments. Rather, the appended claims should be construed to include other variants and embodiments of the invention which may be made by those skilled in the art without departing from the true spirit and scope of the present invention.

What is claimed:

1. A transceiver comprising a housing, and an optical source and optical photodetector mounted therein, wherein the housing comprises a carrier upon which the source and photodetector are mounted and a cover mounted over the carrier, the housing including an integral wall extending between the source and photodetector so as to electrically isolate the source and photodetector.

2. The transceiver according to claim 1 wherein the source and photodetector are mounted to separate circuit boards which are mounted to the carrier.

3. The transceiver according to claim 2 wherein the boards are mounted vertically to the carrier so that the source and photodetector face each other.

4. The transceiver according to claim 1 wherein the cover is electrically connected to the wall so as to electrically ground the cover to the carrier.

5. The transceiver according to claim 4 wherein the cover includes conductive fingers extending from a top portion of the cover, which fingers mechanically engage the wall when the cover is mounted over the carrier.

6. The transceiver according to claim 1 wherein optical connectors are coupled to the source and photodetector, and the carrier further comprises a front section including slots wherein the connectors are mounted, and receptacles capable of receiving optical fiber plugs.

7. The transceiver according to claim 3 wherein the carrier further comprises a rear portion including slots which receive edges of the circuit boards.

8. The transceiver according to claim 1 wherein the wall includes a kink for accommodating a larger device on one side of the wall than the other side of the wall.

9. The transceiver according to claim 1 wherein the carrier and wall comprise zinc.

10. The transceiver according to claim 1 wherein the thickness of the wall is within the range 432 to 584 microns, and the height of the wall is within the range 8.20 to 8.46 mm.

11. The device according to claim 1 wherein the wall is integral with the carrier.

12. A method of fabricating a transceiver comprising the steps of providing a housing comprising a carrier and cover, and having an integral wall, and mounting a source and photodetector to the carrier on opposite sides of the wall to electrically isolate the source and photodetector.

13. The method according to claim 12 wherein the source and photodetector are first mounted to separate circuit boards which are then mounted to the carrier.

14. The method according to claim 13 wherein the boards are mounted vertically to the carrier so that the source and photodetector face each other.

15. The method according to claim 12 wherein the cover is electrically connected to the wall so as to electrically ground the cover to the carrier.

16. The method according to claim 15 wherein the cover includes conductive fingers extending from a top portion of the cover, which fingers mechanically engage the wall when the cover is mounted over the carrier.

17. The method according to claim 12 wherein optical connectors are coupled to the source and photodetector, the carrier further comprises a front section including slots and receptacles capable of receiving optical fiber plugs, and the connectors are mounted in the slots and aligned with the receptacles such that optical coupling is provided to the source and photodetector when the fiber plugs are inserted in the receptacles.

18. The method according to claim 14 wherein the carrier further comprises a rear portion including slots, and the boards are mounted so that edges of the boards are slidably mounted in the slots.

19. The method according to claim 12 wherein the wall is formed with a kink so as to accommodate a larger device on one side of the wall than the other side.

20. The method according to claim 12 wherein the wall is integral with the carrier.
